(19) United States
(12) Patent Application Publication
(10) Pub. No.: US 2011/0152557 A1
(43) Pub. Date: Jun. 23, 2011

(54) Freezing Point-Lowering Surface Coatings

(75) Inventors: Martina Hirayama, Nussbaumen (CH); Konstantin Siegmann, Zurich (CH); Giuseppe Meola, Winterthur (CH)

(73) Assignee: CLARIANT FINANCE (BVI) LIMITED, Tortola (VG)

(21) Appl. No.: 13/055,386

(22) PCT Filed: Jul. 23, 2009
(86) PCT No.: PCT/CH2009/000263

§ 371 Date: Mar. 10, 2011

(30) Foreign Application Priority Data
Jul. 25, 2008 (EP) 08013421.6

(51) Int. Cl. C07F 7/10

(52) U.S. Cl. 556/419

(57) ABSTRACT

The present invention relates to substrates comprising an outer functional layer characterized in that said layer possesses functional groups of formula (I),

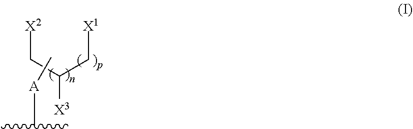

wherein the substituents are as defined in the specification; freezing point reducing surfaces, particularly surfaces which by application of a specific layer provide a freezing point reducing effect; further compounds suitable to establish such surfaces; devices comprising such surfaces; methods for manufacturing such compounds; surfaces and devices as well as the use of said compounds and surfaces in various applications.

### BACKGROUND

The present invention relates to freezing point reducing surfaces, particularly surfaces whish show an freezing point reducing effect by application of a specific surface layer; further to compounds useful for obtaining such surfaces; components comprising such surfaces; processes for manufacturing the compounds, surfaces and components as well as the use of the above compounds and surfaces in various fields of application.

### PRIOR ART

Freezing of surfaces, or the avoidance or delay thereof is a known and well-investigated field. Unwanted freezing takes place on the most distinct surfaces; surfaces of power plants (such as rotor blades of a wind power plant), of means of transportation (such as air wing and rotor blade surfaces, viewing windows) and of wrappings are named as an example.

Ayres et al. (J. Coat. Technol. Res., 4(4) 473-481, 2007) describe coatings which are based on sol-gel systems comprising titanium alcoxylates, tripropylenglycole and glycol. These coatings show an anti-icing effect, which is assigned to the delayed liberating of glycol. This effect is based on the colligative effect, which is known for a long time for glycols. This effect can only be obtained by liberating molecules; it is thus not a freezing point reduction in the sense of the present invention. The coatings described by Ayres et al. are considered disadvantageous for various reasons, particularly due to its limited effective period and its limited use.

Heneghan et al. (Chemical Physics letters 385 (2004), 441-445) investigate crystallization on glass surfaces which are coated with a self-assembling mono-layer of a non-substituted alkyle siloxane. However, detailed measures for manufacturing freezing point reducing surfaces cannot be taken from this document.

Somlo et al. (Mechanics of Materials 33 (2001) 471-480 describe aluminum surfaces coated with a self-assembling mono-layer of a non-substituted alkyle siloxane as well as its adhesion reducing effect on ice. Somlo et al thus achieve a adhesion reducing effect on ice; it is thus not a freezing point reduction in the sense of the present invention. The authors conclude from their observations an applicability in anti-icing effects. These coatings are considered disadvantageous for various reasons, particularly due to its limited effectiveness and effective period.

Okoroafor et al. (Applied Thermal Engineering 20(2000)737-758) describe aluminum surfaces coated with a cross-linked polyvinyl pyrrolidone or polymethyl meth-acrylate respectively. These coatings show an anti-icing effect, which is assigned to the swelling of the above-identified polymers. Okoroafor et al describe a delay in condensation; it is thus not a freezing point reduction in the sense of the present invention. Detrimental is the insufficient adhesion of the polymers on the surface; the authors therefore propose a combination with a PIB matrix or a polyester mesh. Further, the proposed coatings prove not to be sufficiently active in its effect and durability.

EP0738771 describes water-soluble surface treatment agents, which are formed from a fluoralkyle alkoxysilane and an alkoxysilane which contains amine groups. Further, the document mentions possible anti-icing properties, along with other properties, of such coatings.

WO2006/013060 describes substituted organo polysiloxanes, which use as a starting material; inter alia hydroxy-substituted siloxanes. The document also mentions the use of said poly-siloxanes as agents for the treatment of surfaces; the use in the context of freezing point reducing properties is, however, not described.

It is thus the purpose of the present invention to provide further (particularly improved) freezing point reducing (“anti-freeze”) surfaces.

This is achieved by the surfaces according to claim 1. Further aspects of the invention are provided in the independent claims and the specification. Advantageous embodiments are provided in the dependent claims and the specification. In the context of the present invention, various embodiments and preferred ranges may be combined at will. Further, specific embodiments, ranges or definitions may not apply or may be omitted.

Important terms that are relevant in the context of the present invention shall be explained in further detail below; these explanations shall apply, provided the specific context does not indicate otherwise.

The term “sol-gel” is generally known, and particularly comprises sol-gels which are formed by hydrolysis and condensation of Si-alkoxides and/or metal-alkoxides. Solgels may consist of one type of precursor or consist of a mixture of different types of precursors.

The term “polymer” is generally known, and particularly contains technical polymers selected from the group comprises polyolefins, polyesters, polyamides, polyurethanes, polyacrylates. Polymere may be present in the form of homo-polymers, co-polymers or blends.

The term “self assembled molecules” (SAMs) or self assembled molecular layers respectively, is generally known and particularly denotes such molecules, that inhere the ability of self assembly upon contact with a substrate.

Provided a compound (polymer, monomer, precursor etc.) is identified as “functionalized” or “non-functionalized”, this relates to the presence or absence of functional groups of formula (I). In case a functionalisation is present, this particularly denotes an effective amount of such functional group to achieve the desired effect.

The term “substrate” is generally known, and particularly contains all shaped bodies having a solid surface that may be coated. Thus, the term substrate is independent from a specific function or dimension. Substrates may be “uncoated” or “coated”. The term “uncoated” denotes such substrates which lack the inventive outer layer; the presence of other layers, however, is not excluded (e.g. a lacquer coat).

The concept of “functional groups” is generally known and denotes atom groups in a molecule, which significantly influence the material properties and reaction behaviour of the molecules containing them. In the context of the present invention the term particularly denotes groups covalently bound to a sol-gel, polymer or self-assembled molecule.

The term “hetero group” is generally known. Particularly, the term covers a grouping of two or more atoms (without considering hydrogen atoms), preferably 2-6 atoms (without considering hydrogen atoms), which interrupt an alkyl chain and whereby the thus interrupted alkyl chain contains at least one hetero atom, preferably selected from the group consisting of N, S and O. By was of example —O—, —S—, —N(H)— are excluded by this term; groupings —N(H)—O— und —N(H)—C(O)—S— are included.

The term “freezing point reduction” (Gefrierpunktserniedrigung), also in combined expressions, such as “freezing point reducing surface” is generally known. Freezing point reduction according to the present invention particularly denotes a temporary or permanent decrease of the freezing point without significantly influencing the melting point (i.e. not or not significantly, e.g. less than 2° C.).

The effect of freezing point reduction may be achieved by different mechanisms, e.g. due to a thermal hysteresis of due to a delay in freezing. Regarding thermal hysteresis, it is believed that this is based on a non-colligative property of the material; this is observed e.g. by anti-freeze proteins in solution. Regarding delay in freezing, it is believed that this based on the absence of nuclei; this is observed when cooling pure water below 0° C. that spontaneously freezes after a certain period of time.

### DETAILED DESCRIPTION OF THE INVENTION

In a first aspect, the invention relates to substrate comprising an outer functional layer, characterized in that said layer possesses functional groups of formula,

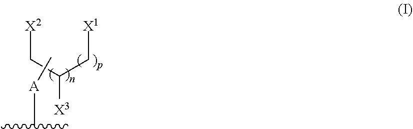

wherein
X¹ represents OH, SH, NH₂, NH(C₁-C₄alkyl), N(C₁-C₄alkyl)₃⁺ and
p represents the integer 1 or
X¹ represents H and
p represents the integer 0;
X² represents OH, SH, NH₂, NH(C₁-C₄alkyl), N(C₁-C₄alkyl)₃⁺;
X³ represents H, C₁-C₄alkyl, OH, SH, NH₂, N(C₁-C₄alkyl)₃⁺;
n represents the integer 0, 1 or 2;
A represents a spacer which is covalently bound.

It was surprisingly found, that such functional groups, which are at least terminal and 1,2- 1,3- and/or 1,4-substituted, provided they are bound via a spacer, provide a pronounced freezing point reducing effect for water, or a thermal hysteresis on surfaces respectively. This effect is considered particularly surprising, as coatings of polyvinyl alcohol, which possesses 1,3-diol moieties, does not show a comparable effect. Without being bound to theory, it is believed that the freezing point reduction is enabled when, on the one hand, hydrophilic groups are present on the surface in the above specified positions (terminal, in 1,2- 1,3- and/or 1,4 position) and, on the other hand, by virtue of a spacer, flexibility and special orientation of such functional groups is improved.

The invention is explained in further detail below.

functional groups of formula (I): These groups are defined above. These groups possess two different regions, a spacer “A” and a head. As shown in formula (I), only a molecular fragment is depicted, the remaining part (the “molecular body”) is represented by a sinuous line. Depending on the choice of the molecular body, the whole molecule may possess only one functional group of formula (I) (particularly in case of SAMs, as outlined below) or a multitude of functional groups of formula (I) (particularly in case of polymers or sol-gels, as outlined below).

According to the invention, the choice of the head may be accomplished in line with the above given definitions. Particularly good results are obtained, provided the head meats one or more of the following criteria.
X¹ preferably represents OH, SH, NH2.
X¹ particularly preferably represents OH, SH.
X¹ very particularly preferably represents OH.
X² preferably represents OH, SH, NH2.
X² particularly preferably represents OH, SH.
X² very particularly preferably represents OH.
X³ preferably represents H, OH, SH, NH₂.
X³ particularly preferably represents H, OH, SH.
X³ very particularly preferably represents H or OH.
n preferably represents the integer 0 or 1.
n particularly preferably represents the integer 0.

According to the invention, the choice of the spacer is not crucial; thereby a multiplicity of spacers, known to the skilled person, may be used. Particularly good results are obtained, provided one or more of the following criteria are met. Suitable spacers comprise 1-20, preferably 2-15, carbon atoms which are arranged in a low branched or linear, preferably linear, chain. A carbon chain is low branched, provided at less than 50%, particularly at less than 20% of the carbon atoms a branching is present. One or more carbon atoms in said carbon chain may be replaced by a heteroatom, a hetero group, an aryl group and/or a heteroaryl group, preferably a hetero group, an aryl group and/or a heteroaryl group. Preferred hetero atoms or hetero groups are —O—, —S—, —S(O)—, —S(O)₂—, —S(O)₂O—, —N(H)—, —N(C₁-C₄-Alkyl)-, —C(O)—, —C(NH)—, and combinations thereof, such as —N(H)C(O)—, —N(H)—C(O)—O—, or —N(H)—C(O)—S—. Preferred aryl groups are phenyl and naphtyl, which are optionally substituted by 1-4 C₁-₄alkyl. Preferred heteroaryl groups are pyridiyl, pyrimidyl, imidazolyl, thienyl, furanyl, which are optionally substituted by one or two C₁₋₄alkyl. As shown in formula (I), spacer A is, on the one hand, bound to the head and, on the other hand, to the molecular body, which is not shown. The connection to the head is accomplished by a covalent single bond, for example a C—C—, C—N—, C—O—, C—S— bond, preferably a C—C— bond, to one of the shown carbon atoms. The connection to said molecular body is accomplished by a covalent single bond, for example a C—C—, C—Si—, C—O—, C—N— bond, preferably by a C—Si bond.

A particular preferred functional group of formula (I) is a functional group of formula (I′)

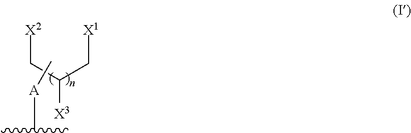

wherein A, n, X¹, X² and X³ have the meaning given above.

Further, a particular preferred functional group of formula (I) is a functional group of formula (I″)

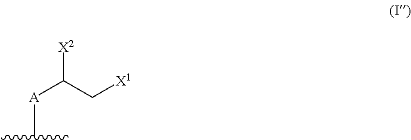

wherein A, X¹ und X² have the meaning given above.

Further, a particular preferred functional group of formula (I) is a functional group of formula (I′″)

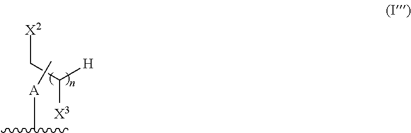

wherein A, n, X² und X³ have the meaning given above.

Further, a particular preferred functional group of formula (I) is a functional group of formula (I″″)

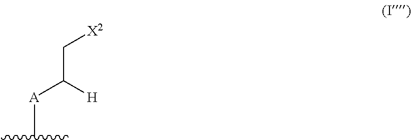

wherein A und X² have the meaning given above.

According to the invention, one or more of the heredescribed functional groups of formula (I), may be present in the outer layer. A combination (or mixture respectively) of different functional groups may be preferred, to combine or strengthen positive properties (synergism), or in case the manufacture of mixtures is simpler when compared to individual compounds.

The invention particularly relates to such outer layers, which contain an effective amount of functional groups of formula (I). The functional groups may be present directly on the surface and/or within the whole outer layer. Even in case the functional groups are only present directly at the surface, they are in an effective amount detectable, for example by XPS. The effective amount predominantly depends on whether the functional groups are present directly on the surface only and/or are present within the whole outer layer.

outer layer: According to the invention, the choice of the outer layer is not crucial, thereby a multitude of layers known to the skilled person may be employed. Suitable outer layers include polymer layers (such as polyurethanes, acrylates, epoxides), layers of the type sol-gel, self assembling molecular layers (such as SAMs). The choice of a suitable layer depends inter alia on the substrate and the choice of the functional group, and may be selected by the skilled person in routine experiments. Layers of the sol-gel type show particularly good results, they are flexible in use and manufacture and are thus preferred.

The connection of the outer layer to a substrate may be accomplished by covalent bonding, ionic bonding, dipolar interaction, or vdW interaction. Self assembling molecular layers and sol-gels are preferably bound by covalent interactions to the substrate. Polymers stick on substrates mainly due to dipolar or vdW interactions.

The thickness of the outer layer is not crucial and may be varied over a broad range. Self assembling molecular layers typically show a thickness of 1-1000 nm, preferably, 1-50 nm; coatings of polymers typically show a thickness of 0.5-1000 μm, preferably 10-500 μm; coatings of the sol-gel type typically show a thickness of 0.1-100 μm, preferably 0.5-10 μm;

The here described “outer layer” contains functional groups of formula (I) (or (I′) to (I″″) respectively); these functional groups are present on the surface and/or within the layer, preferably in an effective amount. As required by the context (e.g. when describing the manufacturing) said outer layer is termed “outer functional layer”. In contrast to this, the “outer non-functionalized layer” is to be seen; which possesses all of the properties of the outer layer but is not equipped with functional groups of formula (I) (or (I′) to (I″″) respectively).

Substrate: According to the invention, the choice of the substrate is not crucial, thereby a multitude of substrates known to the skilled person may be employed. Suitable substrates include metallic materials, ceramic materials, glass-type materials and/or polymeric materials. Preferred metallic materials are, in the context of the present invention, alloys of aluminium, iron and titanium. Preferred polymeric materials are, in the context of the present invention are polymerizates, polycondensates, polyadducts, resins as well as composite materials (e.g. GRP). The substrate itself may be assembled of a multitude of layers (sandwich type structure) or already contain a coating (e.g. a lacquer) or may be treated mechanically or chemically (e.g. etched, polished).

The invention further relates to the use of an outer layer as a freezing point reducing (“anti-freeze”) coating, whereby said layer comprises functional groups of formula (I) as outlined above. In addition to the above given definitions, the substituents may include the following meanings: X¹ may additionally represent H in case p represents the integer 0. Consequently, the invention also relates to such coatings wherein the functional group is either i- or tri-functional (p=1 ad X¹ does not represent hydrogen) or mono-functional (p=0 and X¹═H). Additionally, A may additionally represent a spacer which contains 1-20 carbon atoms wherein one or more carbon atoms are replaced by a heteroatom. Consequently, the invention also relates to such coatings wherein the spacer is formed by an ether (—O—), thio-ether (—S—), amine (—NH—), alkylamine (—N(C₁-C₄alkyl)-).

The invention further relates to a method of using an outer layer as described herein as anti-freeze coating.

Surprisingly, a freezing point reduction, as defined above, could be achieved by the modified surfaces as described herein. As thermal hysteresis/delay in freezing are laboriously to determine, the difference of the freezing point of water on a glass surface and on a modified surface according to the invention is determined and considered as a value for the freezing point reduction.

In a second aspect, the invention relates to a process for manufacturing a substrate with an outer layer as described above.

The manufacture of coated substrates itself is known, but was not yet applied to the specific components as described herein. In principle, the manufacturing processes depend on in which process step the functionalization with a group of formula (I) takes place. Further, the processes distinguish whether said outer layer is of the sol-gel type, a polymer layer or a self assembling molecular layer.

Accordingly, the invention relates to a process for manufacturing a substrate as described herein characterized in that either a) a non-coated substrate is provided and coated with an outer functionalized layer as described herein or b) a substrate, which is coated with a non-functionalized but functionalizable coating is provided and equipped with functionalized groups of formula (I).

Process a) In principle, the coating with an outer functionalized layer may be accomplished according to any known process; preferred embodiments are listed below. The manufacture or materials comprising functional groups of formula (I) (sol-gels, polymers or self assembling molecules comprising (I)) is known per se or may be accomplished in analogy to known processes and is explained below.

Process b) Substrates comprising an outer non-functionalized, but functionalizable, layer are known per se or may be obtained in analogy to known processes. The equipment of such substrates with functionalized groups of formula (I) comprises known chemical reactions of suitable precursors of formula (I), with said outer non-functionalized layer; typical reactions are addition reactions or substitution reaction, which are optionally catalysed.

Preferred embodiments of the described manufacturing process are explained in detail below. Further, in the context of the various manufacturing processes, it is referred to the examples.

Sol-Gel layers: Provided the outer layer is of the sol-gel type, the manufacturing of the inventive substrates comprises either i) Supply of a sol-gel and application of said sol-gel to a non-coated substrate; or ii) supply and application of a sol-gel precursor on a non-coated substrate and subsequent hydrolysis and condensation, thereby forming a sol-gel. The supply of a sol-gel from the corresponding precursors in known, or may be accomplished in analogy to known processes by using suitable precursors that are hydrolysed and condensed. The application of a sol-gel, or sol-gel-precursor respectively, is known per se and may be accomplished in analogy to known processes, for example by spin-coating, dip-coating, spraying or flooding. The precursors used for these processes already contain functional groups of formula (I). Preferred is the manufacturing according to i).

Polymer layers: Provided the outer layer is a polymer layer, the manufacturing of the inventive substrates comprises either i) Supply of a polymer which is optionally distributed in a liquid, and application of said polymer to a non-coated substrate; or ii) the application of monomers which are optionally distributed in a liquid, to a non-coated substrate with subsequent polymerisation; or iii) the supply of a substrate with an outer non-functionalized by functinoalizable polymer layer and conversion of said polymer layer with compounds containing functional groups of formula (I). The supply of a polymer comprising functional groups of formula (I) from the corresponding monomers in known, or may be accomplished in analogy to known processes by using suitable monomers that are subjected to a polymer-forming reaction (polymerization, polycondensation, polyaddition). Such polymer-forming reactions may be catalytically, radically, photochemically (e.g. by UV) or thermally initiated. Either monomers containing functional groups of formula (I) (route i and ii) may be polymerized, or monomers not containing functional groups of formula (I) may be polymerized and the thus formed non-functionalized polymers are then converted in one or more additional reactions to functionalized polymers (route iii). It may further be necessary or preferable to equip the functional groups of formula (I) with protective groups during the manufacturing process. The supply of polymer or of the respective monomer may take place in pure form or in diluted form. i.e. a liquid containing polymer/monomer (suspension, emulsion, solution). The application of polymers, or monomers respectively, is known per se and may be accomplished in analogy to known processes, for example by spin-coating, dip-coating, spraying or flooding.

Self-assembling molecular layers: Provided the outer layer is a self assembling molecular layer, the manufacturing of the inventive substrates comprises either i) the conversion of a non-coated substrate with self-assembling molecules or ii) supply of a substrate with an outer non-functinoalized but functinoalizable SAM-layer and conversion of said SAM-layer with compounds comprising functional groups of formula (I). The supply of self-assembling molecules from the respective starting materials is known or may be accomplished in analogy to known processes using suitable starting materials, e.g. by substitution- and/or redox-reactions. The conversion of non-coated substrates with the above identified molecules is known per se and may be accomplished in analogy to known processes for example by CVD, spin-coating, dip-coating, spraying or flooding. The molecules used for process i) already contain the functional groups of formula (I) as described herein; the molecules used for process ii) do not yet contain functional groups of formula (I). Process ii) is preferred in case the functional groups of formula (I) posses a comparatively high molecular mass. It may further be necessary or preferable to equip the functional groups of formula (I) with protective groups during the manufacturing process. The protection and de-protection of such molecules is known to the skilled person.

The manufacturing processes described herein may be followed by, or preceded from, additional purification-, reprocessing and/or activation-steps, which are known per se. Such additional steps depend, inter alia, from the choice of components and are known to the skilled person. These additional steps may be of the mechanical type (e.g. polishing) or of the chemical type (e.g. etching, passivating, activating, bating)

In a third aspect, the invention relates to devices comprising the coated substrates as described above. As already mentioned, there is a need to provide anti-freezing properties to a large variety of devices. Thus, the present invention relates to such devices in its broadest sense. In particular, devices are comprised that are to be used in power generation or power supply devices that are to be used in means of transportation; that are to be used in food industries; that are to be used in devices for measuring and regulation; that are to be used in heat transfer systems; that are to be used in oil- and natural gas transportation.

As an example, the following devices/appliances are identified:

Power generation or power supply devices: rotor blades of a wind power plant, high-voltage power lines.

Means and appliances of transportation: airfoils, rotor blades, body, antennas, windows of airplanes; windows of vehicles; body, mast, fin-rudder, rigs of ships; outer surfaces of railway cars; surfaces of railway cars; surfaces of road signs.

Food industries: linings of cooling devices, packages of foodstuff.

Devices for measuring and regulation: sensors.

Heat transfer systems: devices for transport of ice mush; surfaces of solar plants; surfaces of heat exchangers.

Oil- and natural gas-transportation: surfaces, which are in contact with gases, upon transport of crude oil or natural gas; for the avoidance of formation of gas hydrates.

According to the invention, the outer layer as described herein may partially or fully coat said device. The degree of coating depends inter alia on its technical necessity. Regarding rotor blades, it may be sufficient to coat the frontal edge for achieving a sufficient effect; regarding viewing glasses, on the contrary, a complete or almost complete coating is preferred. To guarantee the freezing point reducing effect, it is important that the functional layer as described herein, is the outermost (upper) layer.

In a fourth aspect, the invention relates to a process for manufacturing the above described devices, characterized in that either

process a) a device comprising an uncoated substrate is provided, and this device is coated with an outer functional layer as described herein or

process b) a substrate according comprising a functional layer as described herein is provided, and this substrate is connected with the device.

These processes are known per se, but not yet applied to the specific substrates. Processes a) and b) mainly differ in the point in time at which the functionalized outer layer is applied (connected).

According to process a), at first the desired device is manufactured and afterwards coated. For this purpose, all known coating processes may be considered, particularly processes which are typically used in the fields of painting, printing or laminating.

According to process a), at first an intermediate product is made (i.e. the coated substrate), which is connected to a pre-product in such a manner that provides the above device. For this purpose, all adhesively joining, force-fitting, form-fitting connecting processes may be considered. Typically, a film is glued or a shaped article is fastened by gluing, welding, clinching or as the case may be.

In a fifth aspect, the invention relates to compounds of formula (II)

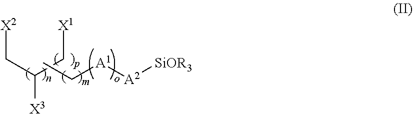

wherein
X¹ represents OH, SH, NH₂, N(C₁-C₄alkyl)₃⁺,
X² represents OH, SH, NH₂, N(C₁-C₄alkyl)₃⁺;
X³ represents H, C₁-C₄alkyl, OH, SH, NH₂, N(C₁-C₄alkyl)₃⁺;
m represents the integer 0, 1 or 2;
n represents the integer 0, 1 or 2;
o represents the integer 0 or 1;
p represents the integer 1;
A¹ represents a hetero atom or a hetero group;
A² represents an alkandiyl having 1-20 carbon atoms, in which optionally one or more of said carbon atoms are replaced independent from each other by an aryl group, a hetero atom or a heteroaryl group;
R represents independent from each other linear or branched C1-C8 alkyl which is optionally substituted;
or
X¹ represents H;
X² represents OH, SH, NH₂, N(C₁-C₄alkyl)₃⁺;
X³ represents H, C0₁-C₄alkyl, OH, SH, NH₂, N(C₁-C₄alkyl)₃⁺;
m represents the integer 0, 1 or 2;
n represents the integer 0, 1 or 2;
o represents the integer 0 or 1;
p represents the integer 0;
A¹ represents a hetero atom or hetero group;
A² represents an alkandiyl having 1-20 carbon atoms, in which optionally one or more of said carbon atoms are replaced independent from each other by an aryl group, a hetero atom or a heteroaryl group;
R represents independent from each other linear or branched C1-C8 alkyl, which is optionally substituted;
or
X¹ represents H;
X² represents OH, SH, NH₂, N(C₁-C₄alkyl)₃⁺;
X³ represents H;
m represents the integer 0, 1 or 2;
n represents the integer 0, 1 or 2;
o represents the integer 1;
p represents the integer 0 or 1;
A¹ represents a hetero group;
A² represents an alkandiyl having 1-20 carbon atoms, in which optionally one or more of said carbon atoms are replaced independent from each other by an aryl group, a hetero atom or a heteroaryl group;
R represents independent from each other linear or branched C1-C8 alkyl, which is optionally substituted;
except the compounds:
4-hydroxy-N-(3-triethoxysilyl)propyl)butyramide;
3-(2-(trimethoxy-xilyl)ethylthio)propane-1,2-diol;
2-ethyl-2-((3-(trimethoxysilyl)propoxy)methyl)propane-1,3-diol;
2-ethyl-2-((3-(triethoxysilyl)propoxy)methyl)propane-1,3-diol.

Due to its trialkoxysilane groups, these compounds are suitable precursors for sol-gels, as described below.

Further, the connection between compounds of formula (II) and the functional groups of formula (I) becomes apparent. The spacer “A” according to formula (I) corresponds to the specific grouping in formula (II), shown below:

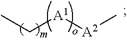

the head according to formula (I) is identical to the head according to formula (II); die “covalent bonding” mentioned in formula (I) is realized in formula (II) by the single bond to the —SiOR₃-residue.

In a preferred embodiment, the substituents of compounds of formula (II) have the following meanings:
X¹ preferably represents OH, SH, NH2.
X¹ particularly preferably represents OH, SH.
X¹ very particularly preferably represents OH.
X² preferably represents OH, SH, NH2.
X² particularly preferably represents OH, SH.
X² very particularly preferably represents OH.
X³ preferably represents H, OH, SH, NH₂.
X³ particularly preferably represents H, OH, SH.
X³ very particularly preferably represents H or OH.
R preferably represents linear or branched, optionally substituted C₁₋₆ Alkyl, whereby the substituents are selected from the group consisting of halogen, hydroxy and C₁₋₆alkoxy;
R particularly preferably represents linear or branched C₁₋₆alkyl, in particular methyl, ethyl, n-, iso-propyl, n-, iso-, sec-, tert-butyl, n-hexyl;
R very particularly preferably represents methyl, ethyl.
m preferably represents the integer 1
n preferably represents the integer 0 or 1.
n particularly preferably represents the integer 0.
o preferably represents the integer 1.
p preferably represents the integer 1.
A¹ preferably represents a hetero atom selected from the group consisting of O, S, N(H), or a hetero group selected from the group consisting of S(O)2, —N(H)—C(O)—, —N(H)—C(O)—O—, —N(H)—C(O)—S—, —N (H)—C(O)—N(H)— nd —O—S(O)₂—.
A¹ particularly preferably represents a hetero group selected from the group consisting of —N(H)—C(O)—, —N(H)—C(O)—O—, —N(H)—C(O)—S—, —N(H)—C(O)—N(H)— and —O—S(O)₂—.
A¹ very particularly preferably represents the hetero group —N(H)—C(O)—S—.
A² preferably represents an alkandiyl having 2-15 carbon atoms, wherein one or more of said carbon atoms is optionally replaces by a phenyl group.

A particular preferred compound of formula (II) is a compound of formula (II′)

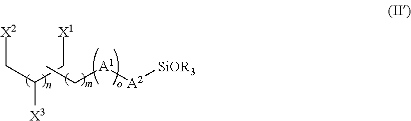

wherein the substituents have the meaning given above, wobei A¹ preferably represents S, O, NH, particular preferably represents S.

A particular preferred compound of formula (II) is a compound of formula (II″)

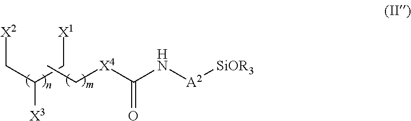

wherein the substituents have the meaning given above, X⁴ represents S, O, CH₂, NH, preferably represents S, O, NH, and particularly preferably represents S.

A particular preferred compound of formula (II) is a compound of formula (II′″)

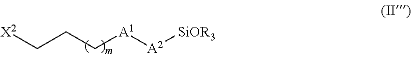

wherein the substituents have the meaning given above, A¹ represents a hetero group. In a compound of formula (II′″) A¹ preferably represents —N(H)—C(O)—, —N(H)—C(O)—O—, —N(H)—C(O)—S—, —N(H)—C(O)—N(H)— and —O—S(O)₂—; and particular preferably represents —N(H)—C(O)—S—. In a compound of formula (II′″) m preferably represents 0. In a compound of formula (II′″) X² preferably represents OH, SH, particularly preferably represents OH. In a compound of formula (II′″) A² preferably represents an alkandiyl having 2-15 carbon atoms, in which one or more of said carbon atoms are replaced by a phenyl group.

The compounds of formula (II) may be present in the form of various optical isomers; the invention includes all these forms like enantiomers, diastereomers or atropisomers; in each case as racemic mixtures, optically enriched mixtures and optically pure compounds.

Further, the compounds of formula (II) may be present in the form of various salts; the invention includes all these forms in particular acid addition salts like halogenides, nitrates, sulfates; as well as salts of alkali- and alkali earth metals.

In a sixth aspect, the invention relates to processes for manufacturing compounds of formula (II). In principle, the manufacturing processes according to a), b) and c) are known reactions, but not yet described for the specific starting materials and are thus subject to the present invention as novel (analogue) processes.

Process a, in case A¹ represents the group —X⁴—C(O)—N(H)—, comprises the conversion of a compound of formula (III)

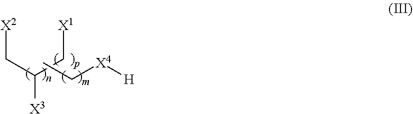

wherein the substituents are as defined in formula (II) and X⁴ represents S, O, CH₂, NH,

with a compound of formula (IV)

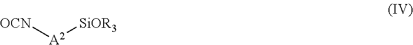

wherein the substituents are as defined in formula (II)

optionally in the presence of a diluent and optionally in the presence of a reaction aid. The conversion of isocyanates (IV) with H-acid compounds (III) is known per se and may be performed in analogy to known processes. The starting materials of formula (III) and (IV) are known or may be obtained according to known processes.

Process b, in case integer o represents 1 (i.e. A¹ is present), comprises the conversion of a compound of formula (V)

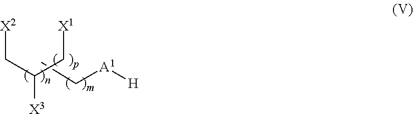

wherein the substituents are as defined in formula (II),

with a compound of formula (VI)

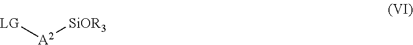

wherein the substituents are as defined in formula (II) and LG represents a leaving group (in particular a halogen; e.g. Cl, Br, I),

optionally in the presence of a diluent and optionally in the presence of a reaction aid. The conversion of an activated compound of formula (VI) with H-acid compounds of formula (V), typically nucleophile substitution reactions, is known per se and be performed in analogy to known processes. The starting materials of formula (V) and (VI) are known or may be obtained according to known processes.

Process c comprises the conversion of a compound of formula (VII)

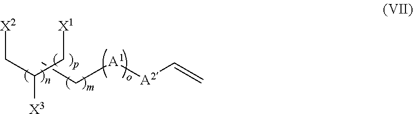

wherein the substituents are as defined in formula (II), A²′ has the meaning of A² with a chain that is shortened by two carbon atoms

with a compound of formula (IIX)

H—SiOR₃ (IIX)

wherein R is as defined in formula (II), optionally in the presence of a diluent and optionally in the presence of a reaction aid. The conversion of silanes of formula (IIX) with alkene derivatives of formula (VII), typically nucleophile addition reactions, is known per se and may be performed in analogy to known processes. The starting materials of formula (VII) and (IIX) are known or may be obtained according to known processes. This process has proven particularly suitable in case the integer o represents 0 (i.e. A¹ is not present).

The processes according to a), b) or c) may be followed by further steps, like purification, isolation, subsequent reactions. The above named processes may lead to reaction mixtures (e.g. region isomers, stereo isomers). Such reaction mixtures may either be directly used in the sol-gel formation, as outlined below, or may be isolated and purified prior to further conversion steps. Corresponding isolating steps and purification steps are known to the skilled person and depend on the produced substitution pattern of compounds of formula (II). Typical purification steps include re-crystallisation (optionally afer salt formation) and chromatographic purification (e.g. by preparative HPLC).

The inventive processes may be performed in the presence of a diluent (solvent of suspending agent). Suitable diluents for the specific reactions are known and may be identified by routine experiments. Alternatively the reactions may be performed in the absence of a diluent (e.g. in substance). In this case, one component may be added in excess.

The inventive processes may be performed in the presence of a reaction aid (catalyst, acid, base, buffer, activating agent and so on). Suitable reaction aids for the specific reactions are known and may be identified by routine experiments.

The inventive processes shall be further explained by reference to the following schemes; furthermore it is referred to the specific examples. The compounds identified below and in the examples are particularly preferred and subject to the present invention. The introduction of a protecting group proved to be particularly beneficial or even necessary in the following schemes, particularly c). Such protection groups may be introduced e.g. by the use of trimethylsilylchloride.

Examples for process a)

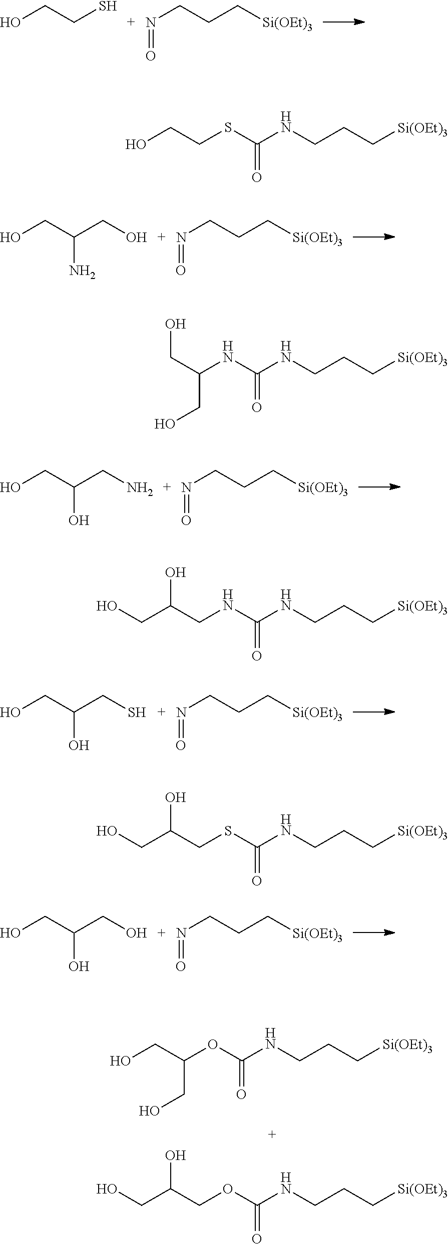

Examples for process b)

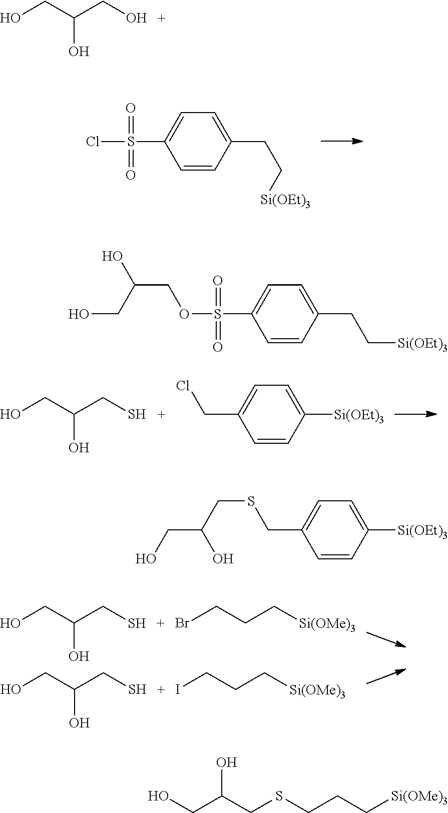

Examples for process c)

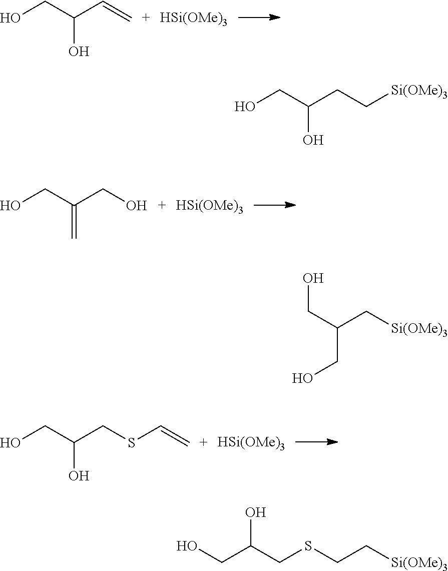

In a seventh aspect, the invention relates to sol-gels containing (i.e. comprising or consisting of) compounds of formula (II). In one embodiment, the inventive sol-gels consist of, or essentially consist of, one or more, preferably one, compound of formula (II). In an alternative embodiment, the inventive sol-gels consists of further alkoxy-silyl compounds, in addition to the one or more, preferably one, compound of formula (II). By such combination, additional physical or chemical properties (like sticking, mechanical properties, processing . . . ) may be influenced.

In an eighth aspect, the invention relates to processes for manufacturing sol-gels containing compounds of formula (II). The manufacturing of a sol-gel starting from the corresponding precursor, a compound of formula (II), may be done in analogy to known processes. Typically, sol-gel formation is accomplished by acid or base catalyzed hydrolysis with subsequent condensation. Preferably, a solution comprising a compound of formula (II) is used in this reaction. Preferred solvents are water and/or C₁₋₄-alcohols, particularly ethanol. Preferably, the reaction is acid-catalyzed, e.g. in the presence of a diluted mineral acid, in particular hydrochloric acid. The reaction temperatures may vary over a broad range; ambient temperatures (ca. 25° C.) proved to be suitable. Regarding details of this process for manufacturing, and alternative processes for manufacturing, it is referred to the corresponding explanations given above (in which reference is made to the functional groups of formula (I)), and to the examples.

In a ninth aspect, the invention relates to coated substrates comprising, as an outer layer, one or more compounds of formula (II) or a sol-gel comprising one or more compounds of formula (II), as well as their manufacturing. Regarding these substrates and its manufacturing, reference is made to the corresponding explanations given above, in which reference is made to the functional groups of formula (I).

In a tenth aspect, the invention relates to the use of a compound of formula (II) and/or a sol-gel comprising a compound of formula (II) as anti-freeze coating. The invention further relates to a method of using a compound of formula (II) and/or a sol-gel comprising a compound of formula (II) as anti-freeze coating.

In an eleventh aspect, the invention relates to devices comprising, as an outer layer, a sol-gel comprising a compound of formula (II), as well as their manufacturing. Regarding these devices and its manufacturing, reference is made to the corresponding explanations given above, in which reference is made to the functional groups of formula (I).

Modes for carrying out the invention: The invention is further illustrated by the following, non-limiting examples.

### EXAMPLE 1

Precursor: In a 50 mL three-necked round bottom flask equipped with a 50 ml dropping funnel, 2.01 g (18.66 mmol) (98%) 1-Thioglycerin (Sigma Aldrich) are provided under protecting gas. 4.42 g (18.68 mmol) (3-isocyanatopropyl) triethoxysilan are weighted in the dropping funnel and added over a period of 15 min. The components immediately react to S-2,3-dihydroxypropyl 3-(triethoxysilyl)propylcarbamothioate (Thioglysilan). The reaction mixture is stirred for 12 hours at room temperature. The synthesized precursor is colorless and viscous.

¹H-NMR (300 MHz in DMSO-d6) δ (ppm), 8.05 (s,1H), 4.85 (d, 1H), 4.54 (t, 1H), 3.75 (q, 6H), 3.48 (m, 1H), 3.34 (d, 1H), 3.28 (t, 2H), 3.00 (m, 2H), 2,88 (m, 1H), 1.45 (m, 2H), 1.14 (t, 9H) 0.45 (m, 2H)

¹³C-NMR (75 MHz in DMSO-d6) δ (ppm), 165.85, 71.16, 64.47, 57.65, 42.23, 32.66, 22.71, 18.18, 7.17

Sol-Gel: Subsequently, 3 g of the product are dissolved in 15 ml ethanol p.a. and combined with 3 mL 0.01 mol/L hydrochloride acid. The reaction mixture is stirred for 30 h at room temperature; the produced Sol-Gel is stored under argon at 5° C.

functionalized substrate: The pre-treated glass slides are dipped into the above Sol-Gel by means of a Dipcoater and subsequently cross-linked in a vacuum cabinet desiccator (1 h/120° C.)

### EXAMPLE 2

Precursor: In a 50 mL three-necked round bottom flask equipped with a 25 ml dropping funnel, 1 g (10.96 mmol) glycerine (water-free) and 15 mL dimethylformamide (water-free) are placed. 2.85 g (11.52 mmol) (3-isocyanatopropyl) triethoxysilan are weighted in the dropping funnel and added over a period of 20 min under protecting gas and stirred for 5 h/50° C. After the reaction, the dimethyl formamide was removed by means of an ultra hight vaccum pump at room temperature, whereby the product was obtained as a viscous clear liquid.

¹H-NMR (300 MHz in DMSO-d6) δ (ppm), 7.05 (s,1H), 4.85 (d, 1H), 4.58 (t,1H), 3.75 (q,6H), 3.48 (m,2H), 3.34 (m, 3H), 2.98 (m,2H), 1.45 (m,2H), 1.14 (t,9H) 0.45 (m,2H)

¹³C-NMR (75 MHz in DMSO-d6) δ (ppm), 156.33, 69.76, 65.38, 52.75, 42.93, 22.94, 18.06, 7.11

Sol-Gel: 3 g of the above product are dissolved in ethanol and hydrolysed with 3 ml 0.01 mol/L hydrochloric acid. The mixture is stirred at room temperature for 24 hrs. The thus produced Sol-Gel is stored under argon at 5° C.

functionalized substrate: The pre-treated glass slides are dipped into the above Sol-Gel by means of a Dipcoater and subsequently cross-linked in a vacuum cabinet desiccator (1 h/120° C.)

### EXAMPLE 3

Precursor: In a 50 mL three-necked round bottom flask equipped with a 25 ml dropping funnel, 2 g (25.59 mmol) 2-Mercaptoethanol (Sigma Aldrich)are placed. 6.33 g (25.59 mmol) (3-iso-cyanatopropyl)triethoxysilan are weighted in the dropping funnel and added over a period of 15 min. The components immediately react to S-2-hydroxyethyl 3-(triethoxysilyl)propyl-carbamothioate. The reaction mixture is stirred for 12 hours at room temperature.

¹H-NMR (300 MHz in DMSO-d6) δ (ppm), 8.1 (s,1H), 4.85 (t, 1H), 3.75 (q, 6H), 3.48 (q, 2H), 3.05 (q, 2H), 2,85 (t, 1H), 1.45 (m, 2H), 1.14 (t, 9H) 0.45 (m, 2H

¹³C-NMR (75 MHz in DMSO-d6) δ (ppm), 165.27, 61.00, 57.66, 43.23, 31.33, 22.70, 18.15, 7.17

Sol-Gel: Subsequently, 3 g of the product are dissolved in 16.4 ml ethanol p.a. and combined with 3.3 mL 0.01 mol/L hydrochloride acid. The reaction mixture is stirred for 24 h at room temperature; the produced Sol-Gel is stored under argon at 5° C.

functionalized substrate: The pre-treated glass slides are dipped into the above Sol-Gel by means of a Dipcoater and subsequently cross-linked in a vacuum cabinet desiccator (1 h/120° C.)

### EXAMPLE 4

Precursor: 4-hydroxy-N-(3-(triethoxysilyl)propyl)butyramid (ABCR) was used as delivered.

Sol-Gel: 3 g of the precursor are dissolved in 17.4 ml Ethanol p.a. and combined with 3.5 mL 0.01 mol/L hydrochloric acid. The reaction mixture is stirred for 24 h at room temperature; the produced Sol-Gel is stored under argon at 5° C. functionalized substrate: The pre-treated glass slides are dipped into the above Sol-Gel by means of a Dipcoater and subsequently cross-linked in a vacuum cabinet desiccator (1 h/120° C.)

Pre-Treatment of the Glass Slides:

The glass slides are pre-treated in a solution consiting of 20% sodium hydroxide solution and 30% hydrogen peroxide in a ratio of 2:1. The period of the pre-treatment (“etching”) is about 3 hours. Subsequently, the glass slides are washed with destilled water and rinsed with ethanol p.a.

Analysis of the Functionalized Substrate:

General description of the experiment:

The experimental set up is shown in FIG. 5, wherein represents
SL gas cylinder with synthetic air
LM1 airflow meter (for adjustment of humidity)
LM2 airflow meter (for adjustment of air flow)
LB air humidifier
HPLC membrane (for retention/splitting of large water droplets)
FM hydrometer
LM3 airflow meter (for measurement of the total air flow)
TK temperature chamber
M microscope
2 water supply
3 pump for liquid nitrogen
4 temperature control
5 water drain
6 nitrogen.

Synthetic air (a mixture of nitrogen and oxygen) of the gas cylinder serves to transport humidity into the temperature chamber. Control of humidity is achieved by an adjustable air flow meter (ROTA), whereby one is intended for adjusting the relative air humidity and the other is intended for the airflow in general. Subsequently, the synthetic air is passed through and air humidifier filled with water. Both airflows are combined behind the air humidifier. Thus, the aimed relative humidity may be adjusted by varying both air flows. The purpose of the HPLC membrane is to ensure homogeneity of size distribution of water droplets, whereby larger drops are retained. By use of a Rotrog Hydrolog, the rel. air humidity of the moistured synthetic air is measured and optionally recorded on a computer. The pump for liquid nitrogen is used for intense cooling (down to −100° C.) of the temperature chamber; the water supply serves for cooling in case of heating steps. After adjusting the parameters, the coated slide is placed in the temperature chamber; afterwards, the cooling ramp is phased in. Monitoring of the water's freezing point is done by microscope; optionally pictures of the freezing behavior are taken and processed via computer.

Measurements in the Temperature Chamber:

The airflow for moisturing the cooling ramp was adjusted to 2 L/min and the relative air humidity was adjusted to 15%. Subsequently, a half-coated glass slide was placed in the temperature chamber and the microscope (Zeiss EC Epiplan-NEOFUIAR 10×/0.25 HD DIC lens or Zeiss LD ACHORPLAN 20×/040 Korr lens) was focused on the interface Glass—coating. For the measurements, the temperature control was adjusted to a final temperature of −100° C. with a cooling rate of 1° C./min.

The following table shows the difference in freezing points between glas (as reference) and coating (examples 1, 2, 3, and 4) at a cooling rate of 1° C./min.

| example | cooling rate 1° C./min |
|---|---|
| 1 | 23.1 ± 1.7° C. |
| 2 | 19.2 ± 0.7° C. |
| 3 | ca. 18-19° C. |
| 4 | ca. 10-12° C. |

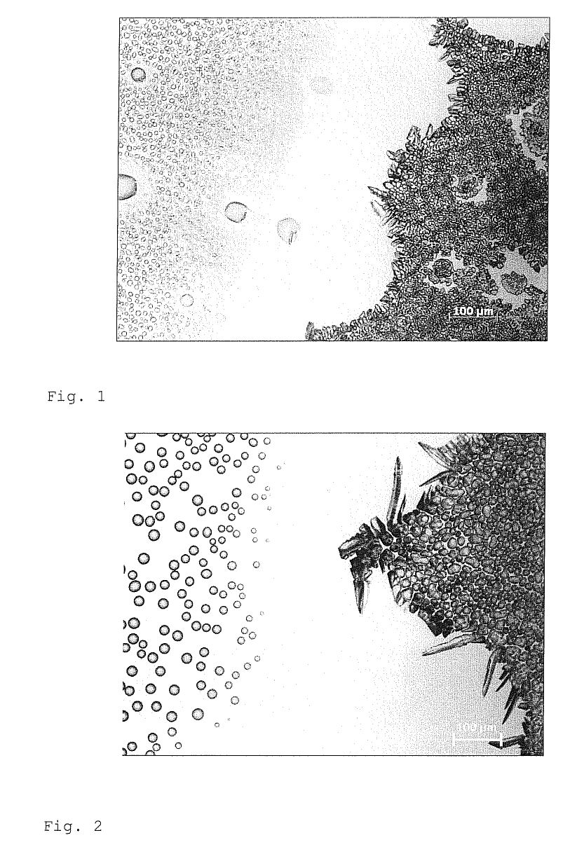

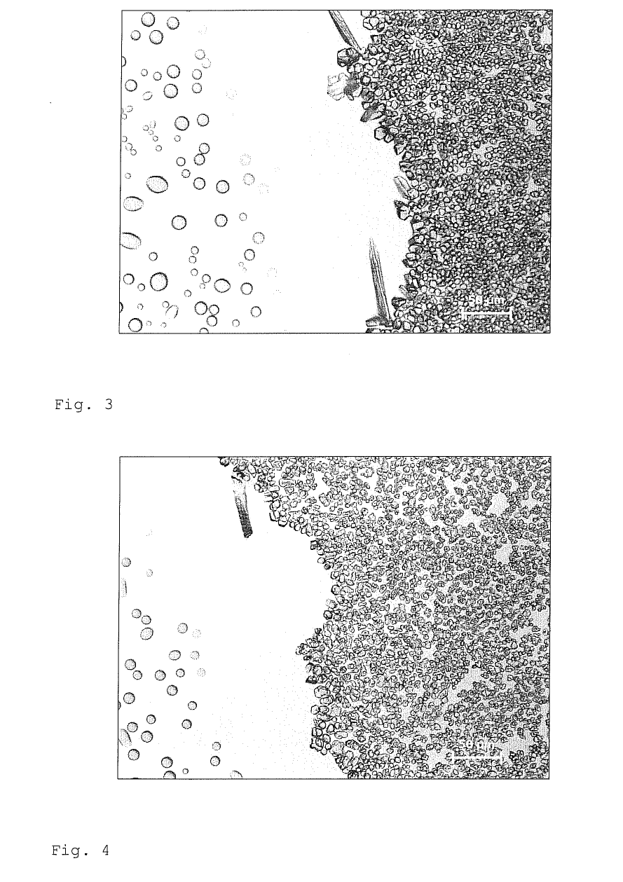

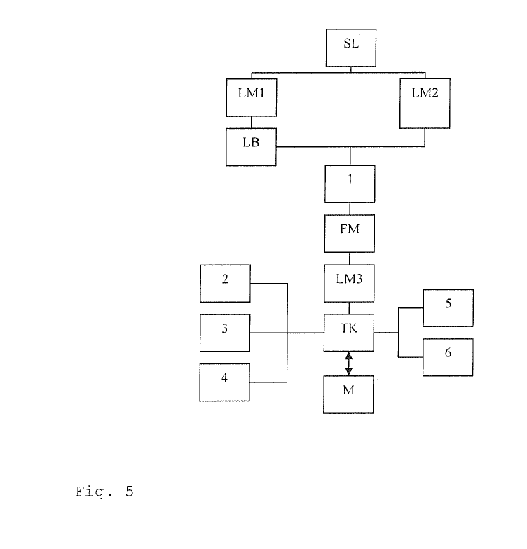

Further, coated substrates according to the examples were examined by microscopy. The pictures taken by microscopy of FIG. 1 show on the side coated according to example 1 (left) water droplets, and on the side which is un-coated (right) ice. Both sides are on the same temperature. The pictures taken by microscopy of FIG. 2 show on the side coated according to example 2 (left) water droplets, and on the side which is un-coated (right) ice. Both sides are on the same temperature. The pictures taken by microscopy of FIG. 3 show on the side coated according to example 3 (left) water droplets, and on the side which is un-coated (right) ice. Both sides are on the same temperature. The pictures taken by microscopy of FIG. 4 show on the side coated according to example 4 (left) water droplets, and on the side which is un-coated (right) ice. Both sides are on the same temperature.

### EXAMPLE 5

In a comparative experiment, 3 aluminium bars, which were coated according to example 3, together with non-coated aluminium bars are subject to an icing process. The icing took place by cooled drizzle at −8° C. It was found that droplets on the coated bar freezed later when compared with the uncoated bar.

1. A substrate comprising an outer functional layer, wherein the outer functional layer comprises at least one functional group of formula (I), 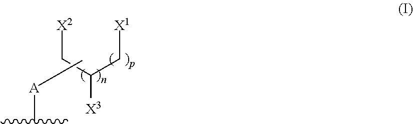
wherein
X¹ is OH, or SH;
X² is OH, or SH;
X³ is H, C₁-C₄alkyl, OH, or SH;
n is the integer 0, 1 or 2;
p is the integer 1;
A is a spacer, which comprises 1-20 Carbon atoms, wherein optionally at least one of the Carbon atoms is replaced by a hetero group, an aryl group and/or a heteroaryl group and wherein
the functional group of formula (I) is covalently bound.

2. A substrate according to claim 1, wherein
n is the integer 0 or
n is the integer 1 and X³ is H, OH, or SH.

3. A substrate according to claim 1, wherein in the spacer A
a. the hetero atoms or heteroatom groups are selected from the group consisting of
i. —S(O)—, —S(O)₂—, —N(H)—, —C(O)—, —C(NH)—
ii. combinations of these groups and
iii. combinations of these groups with —O—, —S—;
b. the aryl groups are selected from the group consisting of phenyl and naphtyl, which are optionally substituted by 1-4 C₁₋₄alkyl; and
c. the heteroaryl groups are selected from the group consisting of pyridyl, pyrimidyl, imidazolyl, thienyl, and furanyl, which are optionally substituted by one or two 1-4 C₁₋₄olkyl.

4. A substrate according to claim 1, wherein the outer functional layer is selected from the group consisting of sol-gel type layers, polymer layers and self-assembled molecular layers.

5. A substrate according to claim 1, wherein the substrate is selected from the group consisting of metallic materials, ceramic materials, glass-type materials, and polymer materials.

6. A process for reducing the freezing point of a substrate, comprising the step of applying an outer functional layer comprising functional groups of formula (I) according to claim 1, in which
X¹ additionally is H and p is the integer 0 and/or
A additionally is a spacer which comprises 1-20 Carbon atoms, in which at least one of the Carbon atoms are replaced by a heteroatom.

7. A process for manufacturing a substrate according to claim 1, wherein either
a. a substrate, which is uncoated, is coated with an outer functional layer, wherein the outer functional layer comprises at least one functional group of formula (I), 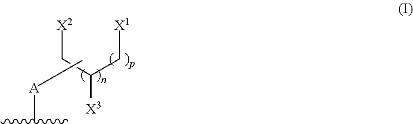
wherein
X¹ is OH, or SH;
X² is OH, or SH;
X³ is H, C₁-C₄alkyl, OH, or SH;
n is the integer 0, 1 or 2;
p is the integer 1;
A is a spacer, which comprises 1-20 Carbon atoms, wherein optionally at least one of the Carbon atoms is replaced by a hetero group, an aryl group and/or a heteroaryl group
and wherein
the functional group of formula (I) is covalently bound or
b. a substrate, which is coated with a non-functionalized but functionalizable coating, is equipped with functional groups of formula (I).

8. A device comprising a substrate according to claim 1.

9. A according to claim 8 selected from the group consisting of
a. rotor blades of a wind power plant, high-voltage power lines;
b. airfoils, rotor blades, body, antennas, windows of airplanes; windows of vehicles; body, mast, fin-rudder, rigs of ships; outer surfaces of railway cars; surfaces of road signs;
c. linings of cooling devices, packages of foodstuff;
d. sensors;
e. devices for transport of ice mush; surfaces of solar plants; surfaces of heat exchangers; and
f. surfaces, which are in contact with gases, upon transport of crude oil or natural gas.

10. A process for manufacturing a device according to claim 8 wherein,
a device comprising an uncoated substrate is provided, and this device is coated with an outer functional layer comprising at least one functional group of formula (I), 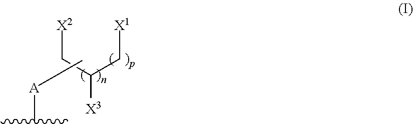
wherein
X¹ is OH, or SH;
X² is OH, or SH;
X³ is H, C₁-C₄alkyl, OH, or SH;
n is the integer 0, 1 or 2;
p is the integer 1;
A is a spacer, which comprises 1-20 Carbon atoms, wherein optionally at least one of the Carbon atoms is replaced by a hetero group, an aryl group and/or a heteroaryl group
and wherein
the functional group of formula (I) is covalently bound.

11. A compound of formula (II) 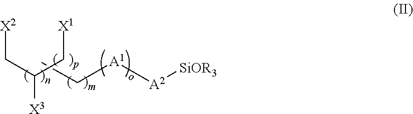
wherein
X¹ is OH, SH, NH₂, or N(C₁-C₄alkyl)₃⁺,
X² is OH, SH, NH₂, or N(C₁-C₄alkyl)₃⁺,
X³ is H, C₁-C₄alkyl, OH, SH, NH₂, or N(C₁-C₄alkyl)₃⁺,
m is the integer 0, 1 or 2,
n is the integer 0, 1 or 2,
o is the integer 0 or 1,
p is the integer 1,
A¹ is a hetero atom or a hetero group,
A² is an alkandiyl having 1-20 Carbon atoms, in which optionally at least one the Carbon atoms is replaced independent from each other by an aryl group, a hetero atom or a heteroaryl group,
R is independent from each other linear or branched C₁-C₈ alkyl which is optionally substituted;
or
X¹ is H,
X² is OH, SH, NH₂, or N(C₁-C₄alkyl)₃⁺;
X³ is H,
m is the integer 0, 1 or 2,
n is the integer 0, 1 or 2,
o is the integer 1,
p is the integer 0 or 1,
A¹ is a hetero group,
A² is an alkandiyl having 1-20 Carbon atoms, in which optionally at least one of the Carbon atoms is replaced independent from each other by an aryl group, a hetero atom or a heteroaryl group,
R is independent from each other linear or branched C₁-C₈ alkyl, which is optionally substituted;
excluding except the compounds:
4-hydroxy-N-(3-triethoxysilyl)propyl)butyramide,
3-(2-(trimethoxy-silyl)ethylthio)propan-1,2-diol,
2-ethyl-2-((3-(trimethoxysilyl)propoxy)methyl)propane-1,3-diol, and
2-ethyl-2-((3-(triethoxysilyl)propoxy)methyl)propane-1,3-diol.

12. A compound according to claim 11, wherein
X³ is H, OH, or SH;
m is the integer 1;
n is the integer 0 or 1;
o is the integer 1;
A¹ is a hetero group selected from the group consisting of —N(H)—C(O)—, —N(H)—C(O)—O—, —N(H)—C(O)—S—, —N(H)—C(O)—N(H)— and —O—S(O)₂—;
A² is an alkandiyl having 2-15 Carbon atoms, in which one of the Carbon atoms is optionally substituted by a phenyl group;
R is linear or branched, optionally substituted C₁₋₆ Alkyl, the substituents being selected from the group consisting of halogen, hydroxy, and C₁₋₆ alkoxy.

13. A process for manufacturing a compound of formula (II) according to claim 11, wherein the process comprises
in the case where A¹ is the group —X⁴—C(O)—N(H)—, the conversion of a compound of formula (III) 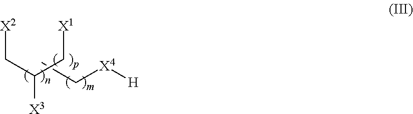
wherein the substituents are as defined in claim 11 and X⁴ is S, O, or NH
with a compound of formula (IV)
OCN-A²-SiOR₃ (IV)
wherein the substituents are as defined in claim 11,
optionally in the presence of a diluent and
optionally in the presence of a reaction aid.

14. A Sol-Gel containing one or more compounds of formula (II) according to claim 11.

15. A process for manufacturing a sol-gel comprising hydrolysis and condensation of a compound according to formula (II) according to claim 11, optionally in the presence of further hydrolysable or condensable compounds.

16. A substrate comprising an outer functional layer, wherein the outer functional layer comprises a Sol-Gel according to claim 14.

17. A process for reducing the freezing point of the surface of a substrate comprising the step of applying Sol-Gel according to claim 14.

18. A device comprising a substrate according to claim 16.

19. A process for reducing the freezing point of the surface of a substrate comprising the step of applying a compound of formula (II) according to claim 11 to the surface of the substrate.

20. A substrate comprising an outer functional layer, wherein the outer functional layer comprises at least one compound of formula (II) according to claim 11.

21. A process for manufacturing a device according to claim 8, wherein a substrate comprising an outer functional layer,
where the outer functional layer comprises at least one functional group of formula (I), 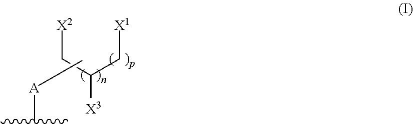
wherein
X¹ is OH, or SH;
X² is OH, or SH;
X³ is H, C₁-C₄alkyl, OH, or SH;
n is the integer 0, 1 or 2;
p is the integer 1;
A is a spacer, which comprises 1-20 Carbon atoms, wherein optionally at least one of the Carbon atoms is replaced by a hetero group, an aryl group and/or a heteroaryl group
and wherein
the functional group of formula (I) is covalently bound, is provided, and this substrate is connected with the device.

22. A process for manufacturing a compound of formula (II) according to claim 11, wherein process comprises in the case where o is the integer 1, the conversion of a compound of formula (V) 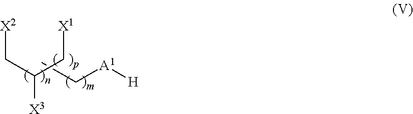
wherein the substituents are as defined in claim 11,
with a compound of formula (VI)
LG-A-SiOR₃ (VI)
wherein the substituents are as defined in claim 11 and LG is a leaving group,
optionally in the presence of a diluent and
optionally in the presence of a reaction aid.

23. A process for manufacturing a compound of formula (II) according to claim 11, wherein the process comprises the conversion of a compound of formula (VII) 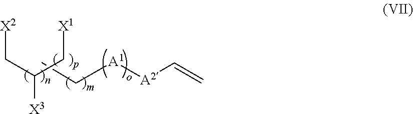
wherein the substituents are as defined in claim 11, A2′ has the meaning of A2 according to claim 11 with a chain that is shortened by two Carbon atoms, with a compound of formula (IIX)
H—SiOR₃ (IIX)
in which R is as defined in claim 11,
optionally in the presence of a diluent and
optionally in the presence of a reaction aid.
